(19) United States
(12) Patent Application Publication
(10) Pub. No.: US 2010/0000428 A1
(43) Pub. Date: Jan. 7, 2010

(54) NON-CONTACT SCREEN PRINTING METHOD AND PRINTING DEVICE THEREOF

(76) Inventor: Tung-Chin CHEN, Taipei (TW)

Correspondence Address: Muncy, Geissler, Olds & Lowe, PLLC, P.O. BOX 1364, FAIRFAX, VA, 22038-1364, US

(21) Appl. No.: 12/235,892

(22) Filed: Sep. 23, 2008

(30) Foreign Application Priority Data
Jul. 2, 2008 (TW) 097124975

(51) Int. Cl. B41L 13/18

(52) U.S. Cl. 101/123

(57) ABSTRACT

A screen printing method and a printing device thereof are revealed. The printing device consists of a printing table, a screen and a printing head. The printing head includes at least one driving member that moves upward and downward so as to drive at least one squeegee moving upward and downward. By precise control of relative distance between the screen and a printed substrate on a surface of the printing table, the squeegee applies a constant pressure to the screen for printing under the condition that the screen doesn't contact with the printed substrate. As to the printed substrate made from fragile and compact materials such as silicon wafer, the thickness and evenness of the ink are precisely controlled.

### BACKGROUND OF THE INVENTION

The present invention relates to a printing method and a device thereof, especially to a especially to a screen printing method and a printing device thereof that precisely controls relative distance between a screen and a printed substrate on a surface of a printing table so as to make a squeegee apply a constant pressure forcing ink through the screen to form an image on the printed substrate uniformly and stably.

The screen printing has been broadly applied to various high-tech products such as liquid crystal glass, touch panel, and silicon wafer etc. Refer to FIG. 1 & FIG. 2, conventional screen printing used a mesh 401a of a screen 40a attached on surface of a printed substrate 70a. By a squeegee 30a applying a constant pressure to the mesh 401a, ink is printed on the printed substrate 70a. During each printing cycle, the printed substrate 70a has received the pressure through the mesh 401a from the squeegee 30a. Thus once the printed substrate 70a is made from fragile and light material, it's easy to crack and bringing loss. When a thinker layer of ink film is printed on the printed substrate 70a, generally the pressure from the squeegee 30a to the screen 40a is reduced so that ink passing through the screen 40a is also reduced. Moreover, the thickness of the ink film on the printed substrate 70a may become uneven or thinned. Thus the defective rate is too high. There is a need to overcome these problems.

### SUMMARY OF THE INVENTION

Therefore it is a primary object of the present invention to provide a non-contact screen printing method that precisely controls relative distance between a screen and a printed substrate on a surface of a printing table so as to make a squeegee apply a constant pressure forcing ink through the screen to form an image on the printed substrate while the screen doesn't contact with the printed substrate. Thereby, the thickness of the ink is precisely controlled. Especially to the printed substrate made from fragile and light material such as silicon wafer, this is important. By such method, not only the fragile printed substrate is protected from cracking due to printing pressure, but the printing evenness and stability are also improved. Therefore, precise printing effect is achieved.

It is another object of the present invention to provide a printing device of a non-contact screen printing method that includes a printing table with a table surface for setting a printed substrate, a screen arranged between the printing table and a squeegee for ink to pass through and printed on the printed substrate, and a printing head with at least one driving member that moves upward and downward so as to drive at least one squeegee moving and pressing against the screen with a constant pressure. The squeegee moves under the condition that the screen does not contact with the printed substrate.

It is a further object of the present invention to provide a screen printing method and a printing device thereof that includes a measuring device for detecting positions and distance of the screen relative to the printing table and sending the data into a computer for presetting. Thus during printing processes, the screens is moved to preset position precisely and quickly under control of a computer while the screen doesn't contact with the printed substrate.

### BRIEF DESCRIPTION OF THE DRAWINGS

FIG. 1 is a schematic drawing showing starting of a conventional screen printing method;

FIG. 2 is during processes of a conventional screen printing method;

FIG. 3 is a schematic drawing showing starting of a screen printing method according to the present invention;

FIG. 4 is during processes of a screen printing method according to the present invention;

FIG. 5 is an explosive view of an embodiment of screening printing equipment according to the present invention;

FIG. 6 is an explosive view of an embodiment of a printing head according to the present invention;

FIG. 7 is a front view showing a screen released from a fixing seat;

FIG. 8 is a front view showing a screen fixed with a fixing seat;

FIG. 9 shows how the “standard zero” position is determined;

FIG. 10 is a schematic drawing showing the screen is set into the fixing seat according to the present invention;

FIG. 11 shows detection of relative distance of the screen to the printing table surface;

FIG. 12 shows a printing status according to the present invention;

FIG. 13 shows movement of the scraper according to the present invention;

FIG. 14 shows static status of the squeegee and the scraper before movement according to the present invention;

FIG. 15 shows the squeegee is moving downward according to the present invention;

FIG. 16 shows the scraper is moving downward according to the present invention;

FIG. 17 shows downward movement of the squeegee in another embodiment of the present invention;

FIG. 18 is a front view of a square squeegee of an embodiment according to the present invention.

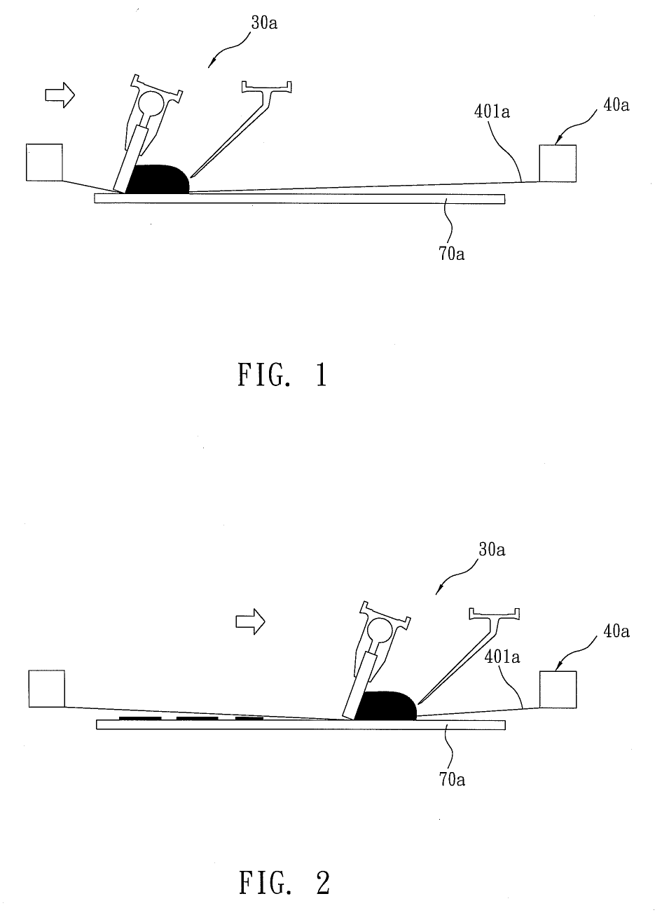

### DETAILED DESCRIPTION OF THE PREFERRED EMBODIMENT

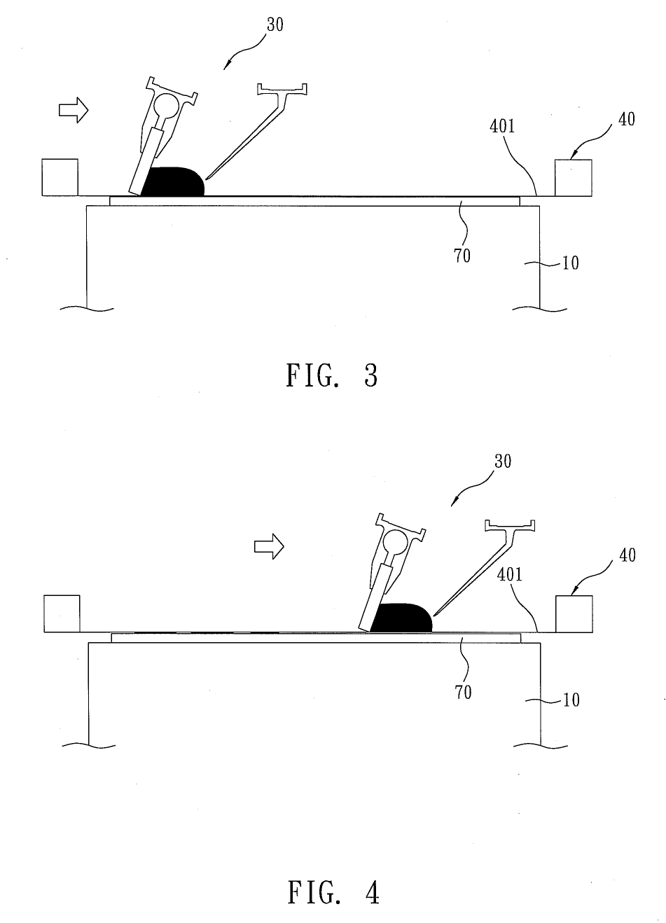

Refer to FIG. 3 & FIG. 4, a non-contact screen printing method according to the present invention is disclosed. By control distance between a screen 40 and a printed substrate 70 on a printing table 10, a squeegee 30 applies a constant pressure forcing ink through a mesh 401 of the screen 40 to form an image on the printed substrate 70. Thus thickness and evenness of the ink can be precisely controlled for improving stability and precision of printing processes. Especially for the fragile and compact substrate 70 such as silicon wafer, such design prevents cracking or damages of the substrate.

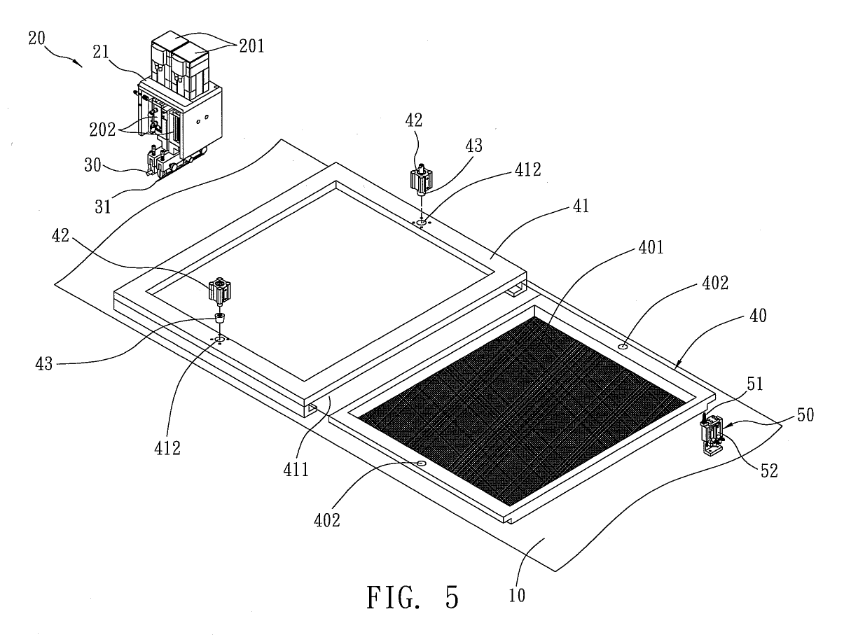

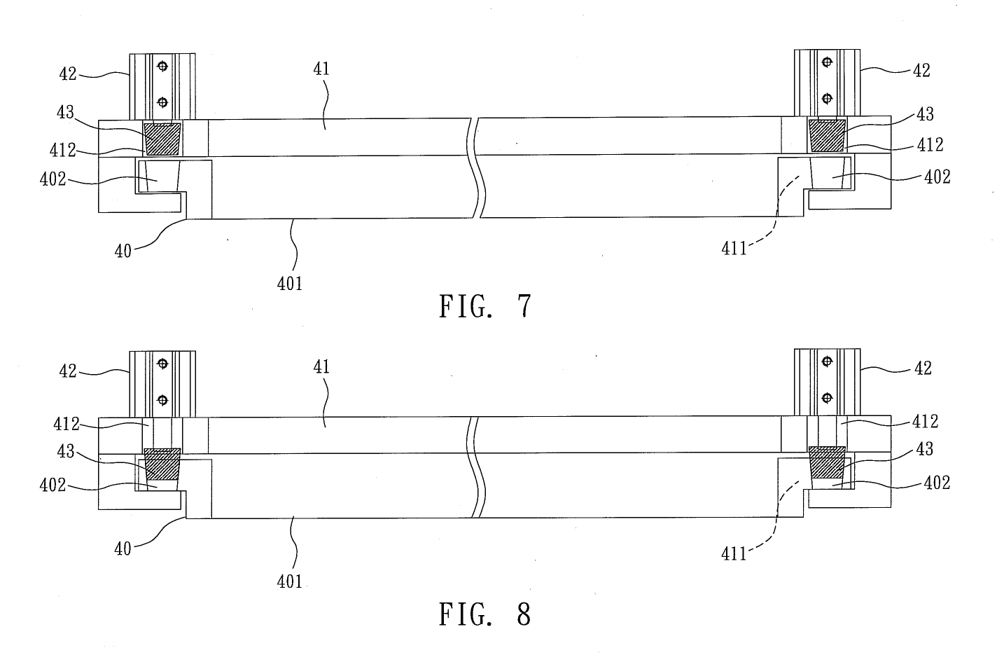

Refer from FIG. 5 to FIG. 8, a non-contact screen printing device according to the present invention consists of a printing table 10, a printing head 20 and a screen 40. The printing table 10 includes a table surface disposed with the printed substrate 70.

The printing head 20 includes at least one driving member 21 that moves upward and downward so as to drive at least one squeegee 30 moving upward and downward. The squeegee 30 applies a constant pressure to and presses against the screen 40 for printing processes. The driving member 21 consists of at least one linear actuator 201 and/or at least one slide pneumatic cylinder 202 that connects with at least one printing scraper 31. The printing scraper 31 moves synchronously with the driving member 21. The driving member 21 further includes a motor so as to drive the linear actuator 201 or the slide pneumatic cylinder 202 moving upward and downward. According to users' requirements, the motor can be a servo motor or a stepper motor. Furthermore, the slide pneumatic cylinder 202 of the driving member 21 further includes an analog constant pressure valve for control of slide pneumatic cylinder 202 so as to make the pressure keep constant.

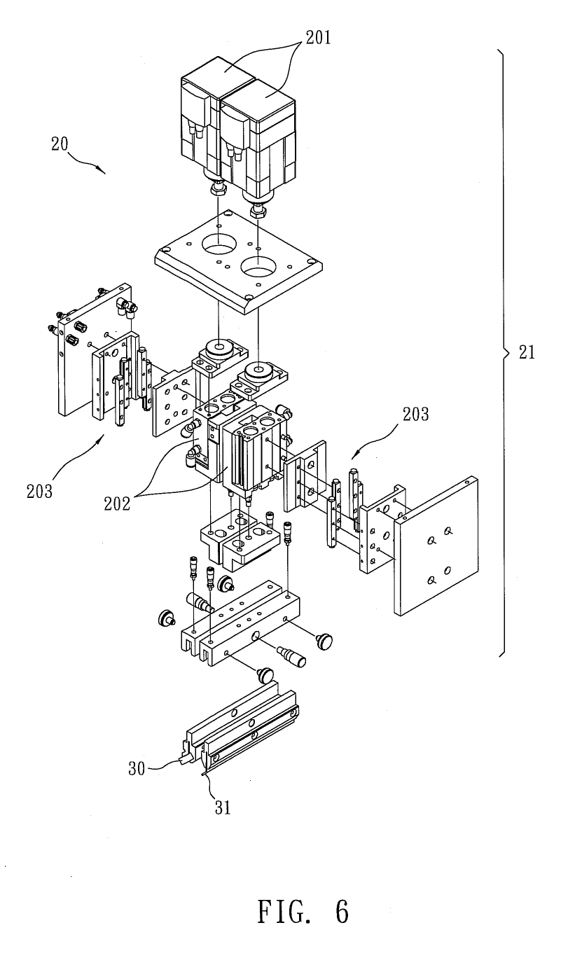

Refer to the embodiment in FIG. 5 & FIG. 6, the driving member 21 of the printing head 20 includes two linear actuators 201 respectively connected with a slide pneumatic cylinder 202, a squeegee 30/a scraper 31 from top to bottom sequentially. By movement of the linear actuators 201, the slide pneumatic cylinder 202 is driven to move upward and downward inside a sliding member 203 while the squeegee 30 and the scraper 31 are further driven to move upward and downward. The movement of the linear actuators 201 is precisely controlled by the servo motor. The slide pneumatic cylinder 202 is disposed with a constant pressure valve (not shown in figure) that is a conventional part such as an analog constant pressure valve. By a digital control way, the pressure of the constant pressure valve keeps constant so that the slide pneumatic cylinder 202 applies a constant pressure and drives the squeegee 30 or the scraper 31 pressing against the screen 40 for printing. Moreover, the ink such as aluminum paste, silver aluminum paste, silver paste, and carbon ink is printed on the printed substrate 70 and during printing processes, the screen 40 does not contact with the printed substrate 70.

Furthermore, the operation way of the above driving member 21 can be changed. For example, the constant pressure valve

not used and the slide pneumatic cylinder 202 connects with the squeegee 30 in a full travel way. That means the squeegee 30 doesn't move along with the slide pneumatic cylinder 202. By the digital control way of the servo motor, the upward/downward movement of the linear actuators 201 is precisely operated so as to drive the squeegee 30 pressing against the screen 40 for printing. This means the movement of the squeegee 30 is precisely controlled by the linear actuators 201 and during printing processes, the screen 40 does not contact with the printed substrate 70.

Generally, the screen 40 is formed by a frame and a mesh 401 in the middle area thereof. The ink passes through the mesh 401 to be printed on the object 70. The screen 40 is fixed on a screen fixing seat 41 and is located between the printing table 10 and the squeegee 30. The screen fixing seat 41 includes a rectangular opening in the middle side and two C-shaped frames with openings facing to each other to form an accommodation space 411 for setting the screen 40. Moreover, at least one cylinder 42 whose axis is connected with a pin 43 thereunder is disposed on the C-shaped frame. By movement of the cylinder 42, the pin 43 is driven to insert through an opening 412 of the screen fixing seat 41 and inserts into a pin hole 402 on the frame of the screen 40 so that the screen 40 is fixed firmly in the accommodation space 411 of the screen fixing seat 41. On the other way, when the cylinder 42 moves to the opposite direction, the screen 40 can be released from the screen fixing seat 41. Thus the screen 40 is released from the screen fixing seat 41 quickly and precisely.

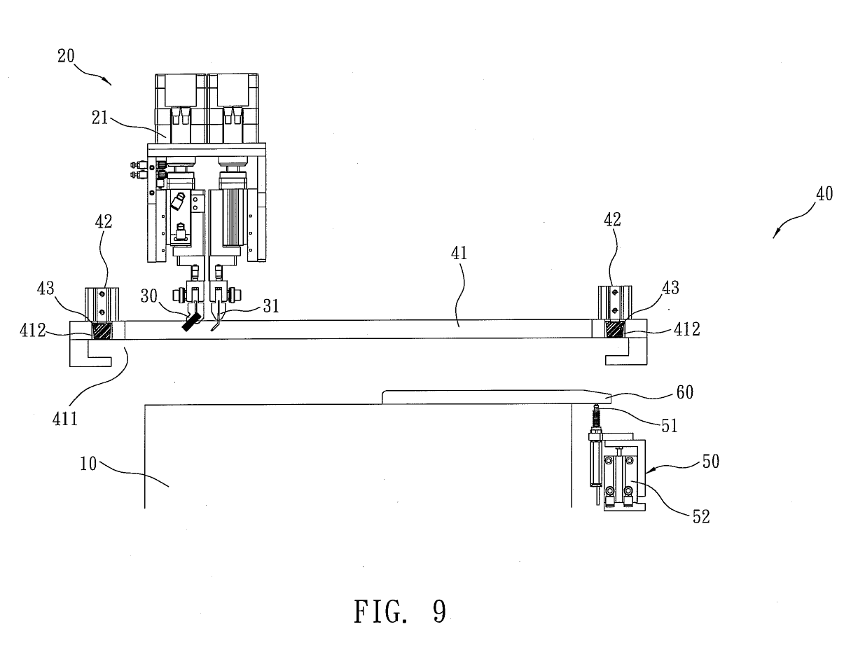

In addition, the device of the present invention further includes a measuring device 50 disposed on an outer side of the printing table 10, at the same height of the table surface of the printing table 10. The measuring device 50 is arranged with a sensor head 51 that connects with a computer of the screen printing equipment and detects feedback data. Refer to FIG. 9, a standard block 60 is put on the table surface of the printing table 10 and is corresponding to the sensor head 51 of the measuring device 50. By driving of a slide pneumatic cylinder 52, the sensor head 51 moves upward and contacts with the standard block 60. Then the measured data of the table surface height is output to the computer and the height is set as “standard zero” position.

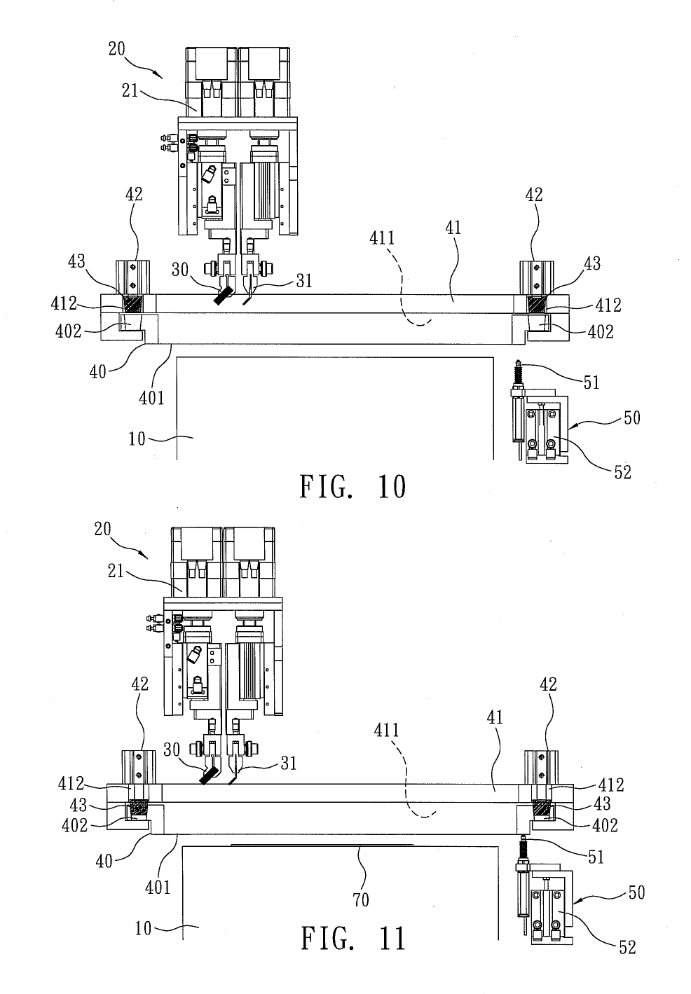

Refer to FIG. 10, & FIG. 11, the figures show how the distance between the printing table surface and the screen 40 is determined. Firstly, the screen 40 is put into the screen fixing seat 41 and is moving downward to a preset printed position that enables the distance between the printing table surface and the screen 40 a bit larger than thickness of the printed substrate 70, as shown in FIG. 10. Then the sensor head 51 of the measuring device 50 moves upward to contact with the bottom surface of the screen 40 and the measured data is sent to the computer. The distance between the screen 40 and the printing table surface is learned. Next the known thickness of ink and related parameters such as the screen strength are input so as to calculate optimum distance between the screen 40 and the printing table surface for being set. Thus the mesh 401 of the screen 40 doesn't contact with the printed substrate 70 during the printing processes, as shown in FIG. 11.

A feasible way that sets distance between a screen 40 and a printing table surface includes the following procedures: calculate optimum distance between the screen 40 and the printing table surface according to thickness of an object to be printed, thickness of ink, and related parameters such as screen strength or deformation. The data can be learned from manufactures of printed substrate or original design of the object to be printed. Then by test printing, the optimum distance that matches requirement of yield rate is further checked. Next detect the distance and the position of the screen relative to the printing table surface by a measuring device such as the above-mentioned measuring device 50 that detects feedback data and the measured data is input into a computer for settings. Thus the screen moves quickly and precisely to the set position for printing under control of the computer.

Refer to FIG. 12, the squeegee 30 is driven by the printing head 20 and is applying a certain pressure. Then the squeegee 30 moves from a front end of the screen 40 to a rear end thereof so as to make the ink pass through the mesh 401 of the screen 40 and print on the printed substrate 70. During the printing processes, the non-contact screen printing is achieved due to non contact between the screen 40 and the printed substrate 70.

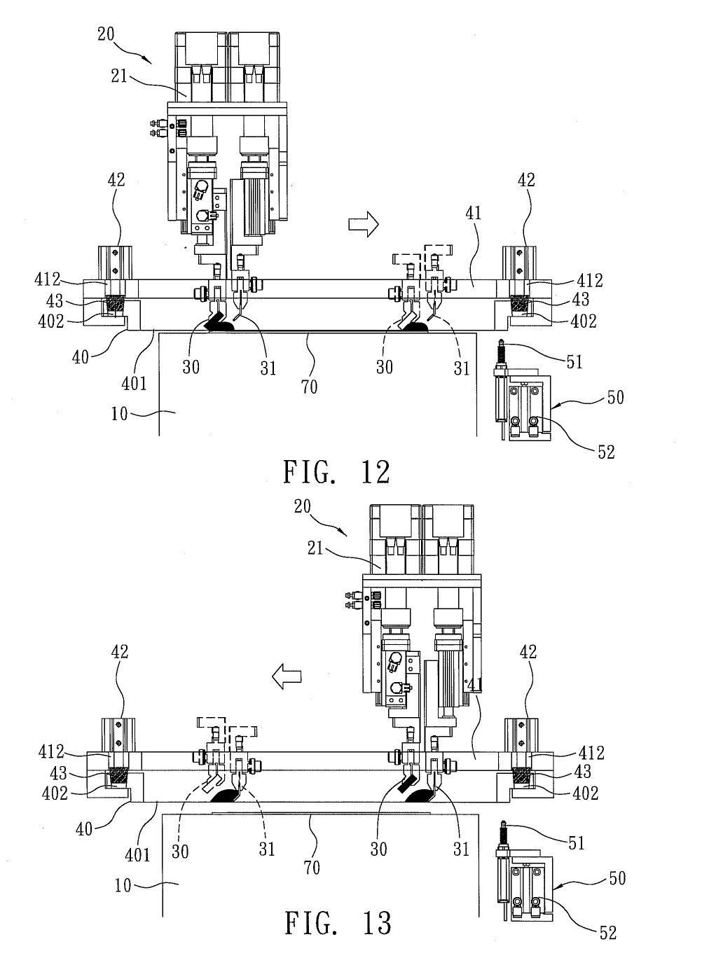

Refer to FIG. 13, after printing processes, the screen 40 rises a little distance to a position printed. By driving of the printing head 20, the squeegee 30 moves upward and the scraper 31 moves downward. Then the scraper 31 moves from the rear end to the front end of the screen 40 so as to push ink from the rear end of the screen 40 to the front end thereof for performing next printing cycle. The scraper 31 can be replaced by the squeegee 30 that also moves from the rear end of the screen 40 to the front end thereof so as to achieve two-way printing.

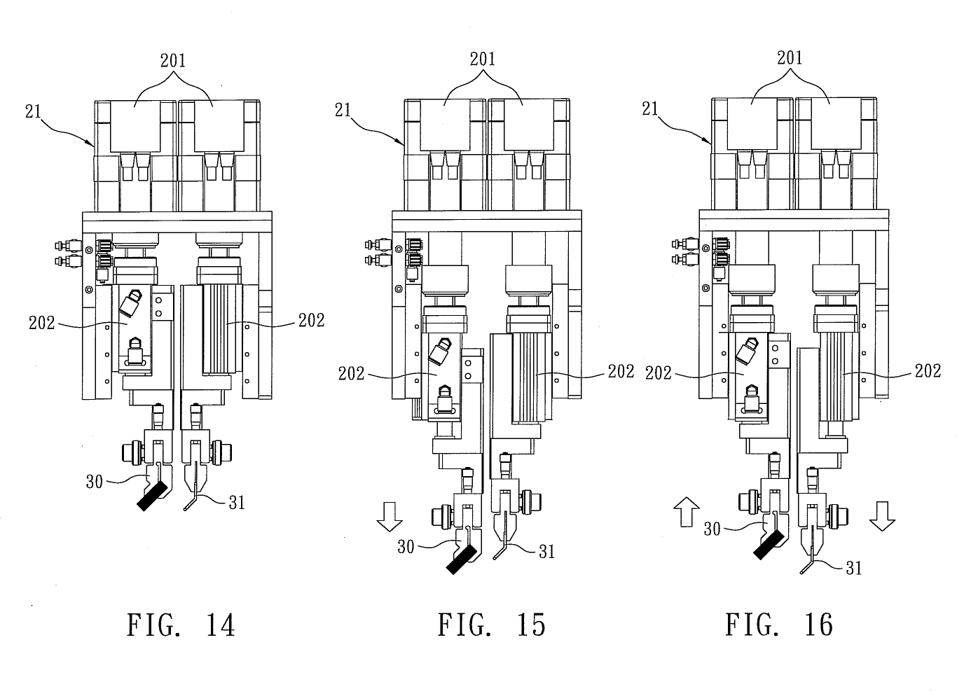

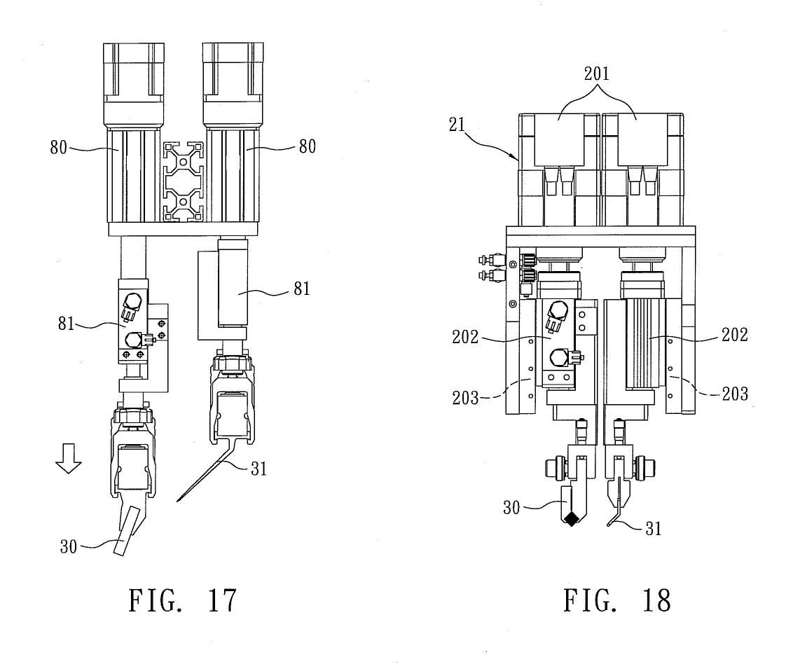

The movement of the squeegee 30 and that of the scraper 31 are further described in details. Refer To FIG. 14, both the squeegee 30 and the scraper 31 have not moved yet. Refer to FIG. 15, the squeegee 30 is driven by the slide pneumatic cylinder 202 to move downward. Refer to FIG. 16, the scraper 31 is driven by the slide pneumatic cylinder 202 to move downward and now the squeegee 30 moves upward. Refer to FIG. 17, a servo device 80 such as a servo motor or a stepper motor in combination with a pneumatic cylinder 81 are used to drive the squeegee 30 or the scraper 31 to move upward/downward.

Refer to FIG. 14 & FIG. 18, there is no limit on shape of the squeegee 30. It can be rectangular (FIG. 14), square (FIG. 18) or splint (not shown in figure) according to users' needs.

A non-contact screen printing method of the present invention includes the following steps:

provide a printing table 10 having a printing table surface disposed with a printed substrate 70;
provide a screen 40 arranged between a squeegee 30 and the printing table surface so that ink on the screen 40 passes through the screen 40 to be printed on the printed substrate 70 over the printing table surface;
set a certain distance between the screen 40 and the printed substrate 70 over the printing table surface;
provide a printing head 20 having at least one driving member 21 and at least one squeegee 30; the driving member 21 drives the squeegee 30 to move downward and press against the screen 40 with a preset constant pressure;
by driving of the printing head 20, the squeegee 30 presses against the screen 40 with a preset constant pressure so as to enable ink passing through the screen 40 and printed on the printed substrate 70;
wherein the distance between the screen 40 and the printed substrate 70 over the printing table surface is calculated according to thickness of the printed substrate 70 and thickness of the ink.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A non-contact screen printing method comprising the steps of:
providing a printing table with a printing table surface for being disposed with a printed substrate;
providing a screen arranged between a squeegee and the printing table surface so that ink on the screen passes through the screen to be printed on the printed substrate over the printing table surface;
setting a certain distance between the screen and the printed substrate over the printing table surface;
providing a printing head having at least one driving member and at least one printing squeegee and the driving member drives the squeegee to move downward;
the squeegee presses against and applies a preset constant pressure to the screen;
by driving of the printing head, the squeegee applies the preset constant pressure forcing ink through the screen to be printed on the printed substrate;
wherein by the certain distance set between the screen and the printed substrate over the printing table surface in combination with the preset constant pressure from the squeegee to the screen, the screen doesn't contact with the printed substrate.

2. The method as claimed in claim 1, wherein the certain distance set between the screen and the printed substrate over the printing table surface is calculated according to thickness of the printed substrate and thickness of the ink.

3. The method as claimed in claim 1, wherein the method further comprising a step of using a measuring device to detect height and position of the printing table surface, in combination with the certain distance set between the screen and the printed substrate over the printing table surface, relative height and position of the screen to the printing table surface are determined.

4. A screen printing device comprising:
a printing table with a printing table surface for setting a printed substrate;
a screen with a frame arranged between the printing table surface and a squeegee and a certain distance is set between the screen and the printed substrate on the printing table surface so as to make ink pass through to be printed on the printed substrate; and
a printing head with at least one driving member that moves upward and downward so as to drive at least one squeegee moving upward and downward and applying a constant pressure to the screen;
wherein the screen doesn't contact with the printed substrate during printing processes due to the certain distance set between the screen and the printed substrate on the printing table surface.

5. The device as claimed in claim 4, wherein the driving member having at least one linear actuator that connects with a squeegee thereunder.

6. The device as claimed in claim 4, wherein the driving member having at least one slide pneumatic cylinder that connects with a squeegee thereunder.

7. The device as claimed in claim 4, wherein the driving member having at least one linear actuator connected with a slide pneumatic cylinder while the slide pneumatic cylinder connects with at least one squeegee thereunder.

8. The device as claimed in claim 4, wherein the driving member further comprising a motor for driving the slide pneumatic cylinder/the linear actuator to move upward and downward.

9. The device as claimed in claim 8, wherein the motor is a servo motor or a stepper motor.

10. The device as claimed in claim 6, wherein the slide pneumatic cylinder further comprising an analog constant pressure valve.

11. The device as claimed in claim 7, wherein the slide pneumatic cylinder further comprising an analog constant pressure valve.

12. The device as claimed in claim 4, wherein the device comprising a measuring device disposed on outer edge of the printing table, at the same height with the printing table surface and connected with a computer.

13. The device as claimed in claim 4, wherein the driving member comprising at least one linear actuator that connected with a slide pneumatic cylinder while the slide pneumatic cylinder connects with at least one scraper thereunder.
